(19) United States
(12) Patent Application Publication
(10) Pub. No.: US 2026/0273450 A1
(43) Pub. Date: Sep. 17, 2026

(54) ADSORBER MODULES AND REACTORS FOR CAPTURE OF CARBON DIOXIDE

(71) Applicant: CORMETECH, INC., Durham, NC (US)

(72) Inventors: Eric Baker Howell, Newberry, FL (US); Chris E. DiFrancesco, Durham, NC (US); Scot Pritchard, Durham, NC (US)

(21) Appl. No.: 19/471,191

(22) PCT Filed: Mar. 28, 2024
(86) PCT No.: PCT/US2024/021969

§ 371 Date: Sep. 30, 2025

Related U.S. Application Data
(60) Provisional application No. 63/456,195, filed on Mar. 31, 2023.

(51) Int. Cl. B01D 53/04; B01D 53/62; B01D 53/96

(52) U.S. Cl. CPC B01D 53/0446; B01D 53/0438; B01D 53/62; B01D 53/96; B01D 2257/504; B01D 2258/0283; B01D 2258/06

(57) ABSTRACT

In one aspect, modules comprising adsorbers are described herein for the removal of CO2 from the ambient atmosphere, flue gas streams, or process gas streams. Such modules, in some embodiments, provide unique structure, fluid flow paths and associated flow management characteristics for the efficient capture and processing of CO2 from fluid streams. In some embodiments, a module for the capture of CO2 from a fluid stream comprises a fluid stream inlet including an inlet duct and an inlet valve for reversibly sealing the inlet duct, and a bed for adsorption of the CO2 from the fluid stream. The module also includes a fluid stream outlet comprising an outlet duct and an outlet valve for reversibly sealing the outlet duct, wherein the fluid stream inlet duct is in fluid communication with piping for collection of an enriched CO2 fluid stream, and the outlet duct is in fluid communication with a source of desorption fluid operable to effectuate desorption of CO2 captured by the bed and/or cooling fluid operable to reduce temperature of the bed.

### RELATED APPLICATION DATA

The present application claims priority pursuant to Article 8 of the Patent Cooperation Treaty to U.S. Provisional Patent Application Ser. No. 63/456,195 filed Mar. 31, 2023 which is incorporated herein by reference in its entirety.

### FIELD

The present application relates to technologies for the removal of carbon dioxide (CO₂) from fluid streams and, in particular, to modules containing adsorbers for the removal of CO₂ from the ambient atmosphere and/or flue gas and/or process streams.

### BACKGROUND

Global warming and associated climate change induced by human activities presents an existential threat to numerous ecosystems and the way of human life as it is currently understood. The mining and burning of fossil fuels are chief contributors to global warming via the massive release of heat trapping gases, including methane and CO₂. CO₂ accounts for the bulk of greenhouse gas emissions, as the concentration of CO₂ has eclipsed the 400 ppm mark in recent years. Current CO₂ levels exceed any concentration in the last 800,000 years.

In view of this alarming trend in atmospheric CO₂ concentration, countries and industry have initiated various mitigation strategies to reduce CO₂ emissions, as well as methane emissions. Electrification of vehicles and transportation systems has drawn considerable attention. Moreover, the transition to green/renewable sources of energy, including wind and solar, has received significant private and public investment. While promising, these mitigation strategies fail to address CO₂ that is currently in the atmosphere as well as CO₂ being generated via current fossil fuel consumption. Accordingly, existing carbon dioxide levels are left to slow, natural degradation processes.

### SUMMARY

In one aspect, modules comprising adsorbers are described herein for the removal of CO₂ from the ambient atmosphere, flue gas streams, or process gas streams. Such modules, in some embodiments, provide unique structure, fluid flow paths and associated flow management characteristics for the efficient capture and processing of CO₂ from fluid streams. In some embodiments, a module for the capture of CO₂ from a fluid stream comprises a fluid stream inlet including an inlet duct and an inlet valve for reversibly sealing the inlet duct, and a bed for adsorption of the CO₂ from the fluid stream. The module also includes a fluid stream outlet comprising an outlet duct and an outlet valve for reversibly sealing the outlet duct, wherein the fluid stream inlet duct is in fluid communication with piping for collection of an enriched CO₂ fluid stream, and the outlet duct is in fluid communication with a source of desorption fluid operable to effectuate desorption of CO₂ captured by the bed and/or cooling fluid operable to reduce temperature of the bed.

In another aspect, reactors for the capture of CO₂ from a fluid stream are provided, wherein the reactors comprise a plurality of modules. A reactor, in some embodiments, comprises a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct. The fluid stream inlet ducts of the first and second modules, in some embodiments, are in fluid communication with common piping for collection of enriched CO₂ fluid streams provided by the first and second modules, and the outlet ducts of the first and second modules are in fluid communication with a common source of desorption fluid operable to effectuate desorption of CO₂ captured by the beds and/or a common source of cooling fluid operable to reduce temperatures of the beds. As described herein, the reactor can comprise one or more additional modules, the one or more additional modules having the architecture of the first and second modules.

In another aspect, methods for removing CO₂ from a fluid stream are provided. In some embodiments, a method for removing CO₂ from a fluid stream comprises providing a reactor including a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct. The fluid stream is passed into the fluid stream inlet ducts of the first and second modules and in contact with the adsorber beds of the first and second modules to remove CO₂ from the fluid stream. The fluid stream, now deficient in CO₂, is passed through the outlet ducts of the first and second modules. After a desired amount of time, the inlet ducts and outlet ducts of the first and second modules are sealed with the inlet and outlet valves, respectively. A desorption fluid is passed into the outlet ducts of the first and second modules to desorb CO₂ captured by the beds and generate an enriched CO₂ fluid stream. The enriched CO₂ fluid stream is passed through the inlet ducts of the first and second modules into piping for collection of the enriched CO₂ fluid stream from the first and second modules.

These and other embodiments are further described in the following detailed description.

### BRIEF DESCRIPTION OF THE DRAWINGS

FIG. 1 is a top cross-sectional view of a module illustrating adsorption and desorption of CO₂ by the module, in addition to module cooling, according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Adsorber Modules

As described herein, modules for the capture of CO₂ from a fluid stream are provided. In some embodiments, a module comprises a fluid stream inlet including an inlet duct and an inlet valve for reversibly sealing the inlet duct, and a bed for adsorption of the CO₂ from the fluid stream. The module also includes a fluid stream outlet comprising an outlet duct and an outlet valve for reversibly sealing the outlet duct, wherein the fluid stream inlet duct is in fluid communication with piping for collection of an enriched CO₂ fluid stream, and the outlet duct is in fluid communication with a source of desorption fluid operable to effectuate desorption of CO₂ captured by the bed and/or reduce temperature of the bed.

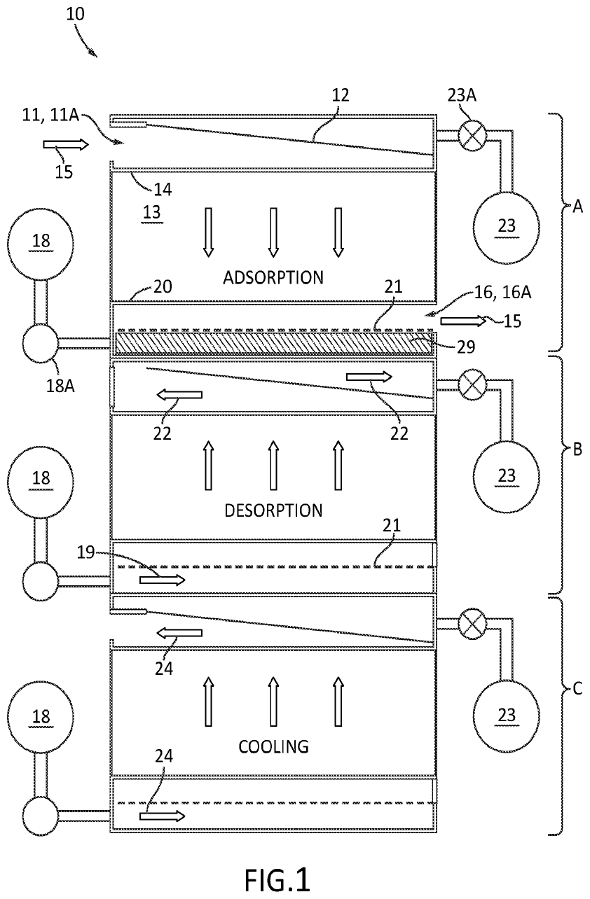

Turning now to specific components, the inlet duct has multiple functionalities for fluid stream management within the module. In one aspect, the inlet provides access of the fluid stream, such as ambient air, a flue gas stream or a process gas stream, to the bed for adsorption of CO₂ from the fluid stream. The inlet duct, for example, can comprise one or more baffles and/or other apparatus for directing the fluid stream to the adsorber bed. Specifications and arrangement of the baffles can be dependent on various considerations including, but not limited to, arrangement of the adsorber bed relative to the inlet duct, source of the fluid stream, and flow rate of the fluid stream within the inlet duct. In some embodiments, the entrance to the inlet duct is non-parallel to the inlet face of the adsorber bed. For example, the inlet duct entrance is normal or perpendicular the inlet face of the adsorber bed. Such an arrangement is illustrated in FIG. 1. Moreover, as illustrated in FIG. 1, a baffle 12 can extend over the inlet face 14 of the adsorber bed 13. The baffle 12 directs a fluid stream 15 entering the inlet duct 11 to the adsorber bed 13.

As described herein, the inlet duct is also in fluid communication with piping for collection of an enriched CO₂ fluid stream. Therefore, the inlet duct is responsible for both directing an inlet fluid stream to adsorbers for CO₂ removal from the fluid stream, and for directing an enriched CO₂ fluid stream to collection piping for further processing. To facilitate this dual functionality, the inlet duct comprises a valve for reversibly sealing the inlet duct. The valve can have any construction consistent with the technical objectives described herein. In some embodiments, the valve can be a panel, door, or louvers. The inlet valve, in some embodiments, resides at a fixed location on the module. In residing at a fixed location, the inlet valve does not move or translate along or over the adsorber bed. The inlet valve can switch between open and closed positions without changing location on the module. As described further herein, the inlet valve is in the open position during CO₂ adsorption from the fluid stream. In contrast, the inlet valve is in the closed position when the inlet duct is directing an enriched CO₂ fluid stream to collection piping during the CO₂ desorption process.

The module also comprises and outlet duct. As with the inlet duct, the outlet duct has multiple functionalities for fluid stream management within the module. In one aspect, the outlet duct passes the fluid stream out of the module after the fluid stream has interacted with the adsorber bed for CO₂ removal. The outlet duct is also in fluid communication with a source of desorption fluid operable to effectuate desorption of CO₂ captured by the adsorber bed and/or cooling fluid operable to reduce temperature of the bed, and/or dry the adsorber bed. The desorption fluid, for example, can be steam or other gas at elevated temperature to effectuate CO₂ desorption. In some embodiments, the cooling/drying fluid may be nitrogen and/or other inert gas. In some embodiments, the outlet duct is non-parallel to the outlet face of the adsorber bed. The outlet duct, for example, can be normal or perpendicular to the outlet face of the adsorber bed, in some embodiments.

To facilitate dual functionality, the outlet duct comprises a valve for reversibly sealing the outlet duct. The valve can have any construction consistent with the technical objectives described herein. In some embodiments, the valve can be a panel, door, or louvers. The outlet valve, in some embodiments, resides at a fixed location on the module. In residing at a fixed location, the outlet valve does not move or translate along or over the adsorber bed. The outlet valve can switch between open and closed positions without changing location on the module. The outlet valve is in the open position during CO₂ adsorption from the fluid stream. In contrast, the outlet valve is in the closed position when the outlet duct is directing desorption fluid to the adsorber bed for the desorption of CO₂. In some embodiments, a diffuser or other fluid distribution media is placed in the outlet duct or adjacent to the outlet duct for distributing the desorption fluid over the outlet face of the adsorber bed. The diffuser, for example, can be a perforated plate or other porous media for distribution of the desorption fluid over the outlet face of the adsorber bed. The diffuser, in some embodiments, extends over the entire area or substantially the entire area of the outlet face of the adsorber bed. In extending over substantially the entire area, the diffuser extends over at least 90 percent, 95 percent, or 99 percent of the outlet face area.

Notably, the diffuser can be positioned in the outlet duct in a manner so as not to interfere with, impede or occlude the fluid stream passing through the adsorber bed and out of the module via the outlet duct. In some embodiments, the diffuser can be positioned in the outlet duct such that only a portion of the fluid stream passing through the adsorber bed also passes through the diffuser. For example, the portion of the fluid stream passing through the diffuser can equal or substantially equal the volume of the outlet duct downstream of the diffuser or beneath the diffuser. Referring to FIG. 1, this volume is illustrated as the hashed region 29. In being substantially equal, the volumes of fluid and duct are within 10 percent, 5 percent or 1 percent. As illustrated in FIG. 1, the diffuser 21 is positioned or arranged in the outlet duct 16 so as to avoid interference with the fluid stream 15 passing through the adsorber bed 13 and out of the module via the outlet duct 16. In this way, the diffuser does not increase pressure drop of module while maintaining the functionality of distributing sufficient desorption fluid 19 in a uniform or substantially uniform manner to the adsorber bed 13 during the desorption step. Additionally, perforated plates and/or other fluid management apparatus can be placed over the inlet and/or outlet faces of the adsorber bed.

The source of desorption fluid, in some embodiments, is located outside of the module, as illustrated in FIG. 1. The desorption fluid source can be placed in fluid communication with the outlet duct via piping controlled by one or more valves. In being located outside the module, the desorption fluid source does not occlude the outlet face of the adsorber bed and/or outlet duct. Therefore, the fluid source for desorption of CO₂ does not contribute disadvantageous fluid flow characteristics that can increase pressure drop and/or other undesirable effects within the module. Similarly, the piping for collection of the enriched CO₂ fluid stream can be located outside of the inlet duct, thereby precluding the collection piping from contributing to fluid flow characteristics that can increase pressure drop and/or other undesirable effects. Piping for collection of the enriched CO₂ fluid stream can be fixedly attached to one or more walls of the module and in communication with the inlet duct via one or more valves. Piping for delivery of the desorption fluid to the outlet duct may also be fixedly attached to one or more walls of the module and in communication with the outlet duct via one or more valves.

The adsorber bed for removal of CO₂ from the fluid stream can comprise any composition, structure, properties and/or arrangement consistent with the carbon capture technical objectives described herein. The chemical species for CO₂ adsorption can be organic compounds or inorganic compounds. In some embodiments, the chemical species comprises one or more organic compounds containing amine functionalities for CO₂ adsorption. For example, the chemical species can comprise one or more polymeric species comprising amine functionalities. In some embodiments, polymeric species comprise polyalkyleneimines, including polyethyleneimine, polypropyleneimine or combinations thereof. Polymeric species comprising amine functionalities for CO₂ adsorption can be linear, branched, or hyper-branched (dendrimer). Polymeric species comprising amine functionalities for CO₂ adsorption can included homopolymers, copolymers, and graft copolymers. Organic compounds comprising amine functionalities for CO₂ adsorption can also include small (non-polymeric) molecules. As an alternative to organic compounds comprising amine functionalities, monolithic structural gas treatment bodies described herein can comprise one or more alkali metal-based functionalities for CO₂ adsorption. In some embodiments, the alkali metal-based functionalities comprise alkali metal oxides operable for CO₂ adsorption.

In some embodiments, the adsorber bed comprises monolithic structural gas treatment bodies including, but not limited to, honeycomb bodies, plates, and/or fiber constructions. The chemical species for CO₂ adsorption are associated with the monolithic structural supports. In some embodiments, for example, the adsorber bed is formed of monolithic structural gas treatment bodies described in Patent Cooperation Treaty Application Serial Number PCT/US2022/051242, which is incorporated herein by reference in its entirety. Alternatively, the adsorber bed can comprise a packed-bed architecture. Composition and structure of the adsorber bed can be selected according to various considerations, including the identity or source of the fluid stream being treated for CO₂ removal. In some embodiments, the fluid stream is ambient air, and the module is designed for direct air capture (DAC) applications. In other embodiments, the fluid stream is a flue gas or process gas from a point source, such as an electric power generation facility, chemical processing facility, cement manufacturing facility, or other industrial facility. In such embodiments, the module is designed for point source capture (PSC) applications. The fluid stream can comprise CO₂ at any desired level. For PSC applications, the CO₂ content of the fluid stream can be diluted with ambient air or other diluent gas prior to processing with modules described herein.

The adsorber bed, in some embodiments, exhibits a pleated arrangement of adsorber bodies, such as that described in U.S. Pat. No. 10,226,737 which is incorporated herein by reference in its entirety. The adsorber bed may also exhibit a parallel bed arrangement of adsorbers, in some embodiments.

### II. Reactors for CO₂ Capture

In another aspect, reactors for the capture of CO₂ from a fluid stream are provided, wherein the reactors comprise a plurality of modules. A reactor, in some embodiments, comprises a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct. The fluid stream inlet ducts of the first and second modules are in fluid communication with common piping for collection of enriched CO₂ fluid streams provided by the first and second modules, and the outlet ducts of the first and second modules are in fluid communication with a common source of desorption fluid operable to effectuate desorption of CO₂ captured by the beds. As described herein, the reactor can comprise one or more additional modules, the one or more additional modules having the architecture of the first and second modules. Modules of reactors described herein can have any composition, architecture, and/or properties described in Section I hereinabove.

III. Methods of CO₂ Capture from a Fluid Stream

In another aspect, methods for removing CO₂ from a fluid stream are provided. In some embodiments, a method for removing CO₂ from a fluid stream comprises providing a reactor including a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct. The fluid stream is passed into the fluid stream inlet ducts of the first and second modules and in contact with the adsorber beds of the first and second modules to remove CO₂ from the fluid stream. The fluid stream, now deficient in CO₂, is passed through the outlet ducts of the first and second modules. After a desired amount of time, the inlet ducts and outlet ducts of the first and second modules are sealed with the inlet and outlet valves, respectively. A desorption fluid is passed into the outlet ducts of the first and second modules to desorb CO₂ captured by the beds and generate an enriched CO₂ fluid stream. The enriched CO₂ fluid stream is passed through the inlet ducts of the first and second modules into piping for collection of the enriched CO₂ fluid stream from the first and second modules. As described herein, fluid passed into the outlet ducts of the first and second modules to desorb CO₂ captured by the beds and generate an enriched CO₂ fluid stream can comprise steam. The steam can have any desired temperature and water content consistent with the technical objectives described herein.

In some embodiments, a purge step is conducted prior to sealing the inlet and outlet valves for initiation of the CO₂ desorption process. In the purge step, the inlet duct remains open and the outlet duct is closed. Ducting to piping for collecting the enriched CO₂ fluid stream from the first and second modules is also closed. A purge fluid is passed into the outlet ducts of the first and second modules to force untreated fluid stream comprising CO₂ back through the inlet ducts and out of the first and second modules. The untreated fluid stream comprising CO₂ can be routed to one or more additional modules operating in the adsorption mode, as described below. The purge step can be administered for a time period sufficient to remove all or substantially all of the untreated fluid stream from the first and second modules. In some embodiments, the purge fluid is the same fluid employed in the desorption step described herein. For example, in some embodiments, steam is used as the purge fluid.

In one aspect, the reactor further comprises at least one additional module, the at least one additional module comprising a fluid stream inlet comprising an inlet duct and an inlet valve for sealing the inlet duct, a bed for adsorption of CO₂ from the fluid stream, and a fluid stream outlet comprising an outlet duct and an outlet valve for sealing the outlet duct, wherein the fluid stream is passed into the inlet duct of the at least one additional module and in contact with the bed of the at least one additional module to remove CO₂ from the fluid stream while the CO₂ captured by the beds of the first and second modules is desorbed to produce the enriched CO₂ fluid stream. In some embodiments, the at least one additional module operates in the same adsorption or desorption mode as the first and second modules. Alternatively, the at least one additional module operates in the opposite mode relative to the first and second modules. The at least one additional module, for example, can operate in the CO₂ adsorption mode while the first and second modules operate in the CO₂ desorption mode, or vice versa. In some embodiments, the at least one additional module comprises a plurality of additional modules. In such embodiments, modules of the reactor are staggered between CO₂ adsorption and CO₂ desorption modes to maintain an efficient collection of enriched CO₂ fluid stream and avoid overloading the enriched CO₂ fluid stream collection apparatus. Moreover, CO₂ capture cycle start and stop times of the modules can also be staggered. One module, for example, may be at the midpoint of a desorption mode while another module is just entering or exiting the desorption mode.

In some embodiments, a cooling process or cycle can be administered following CO₂ desorption from a module. During the cooling cycle, the inlet duct remains open and the outlet duct is closed. Ducting to piping for collecting the enriched CO₂ fluid stream from the module is also closed. A cooling fluid is passed into the outlet duct of the module and through the adsorber bed. The cooling fluid exits the module via the open inlet ducting. In some embodiments, the cooling fluid is an inert gas, such as nitrogen or argon. Alternatively, the cooling fluid can be deficient in oxygen or other oxidative species. The cooling fluid, for example, can be the fluid stream deficient in CO₂ after being treated by the adsorber bed. In such embodiments, the deficient CO₂ stream can be recirculated through the system to serve as the cooling fluid. The cooling cycle can be administered for a time period sufficient to cool the adsorber bed to the desired temperature.

FIG. 1 illustrates operation of a module during various phases including CO₂ adsorption, CO₂ desorption, and adsorber bed cooling. In block A of FIG. 1, the module 10 is functioning to remove CO₂ from a fluid stream 15. The valve 11A of the inlet duct 11 is in the open position, and the fluid stream 15 enters the inlet duct 11. The fluid stream is directed to the inlet face 14 of the adsorber bed 13 and passes through the adsorber bed 13 for removal of CO₂ from the fluid stream 15. The fluid stream 15, now having a lower or no CO₂ content, is passed out of the adsorber bed 13 and into the outlet duct 16. The valve 16A of the outlet duct 16 is in the open position permitting the CO₂ deficient fluid stream 15 to pass out of the module 10. The module 10 can be operated in the adsorption phase for any time period consistent with the technical objectives described herein.

In block B of FIG. 1, the module is functioning to desorb the captured CO₂ from the adsorber bed to provide an enriched CO₂ fluid stream for collection. In the desorption mode, the inlet valve 11A and outlet valve 16A are in the closed position. The outlet duct 16 is in fluid communication with source 18 of desorption fluid 19, such as steam. The steam source 18 is located outside the module 10 and is connected to the outlet duct 16 via piping with one or more valves 18A. Steam 19 is flowed into the outlet duct 16 and is passed into the outlet face 20 of the adsorber bed 13. In some embodiments, a diffuser 21 is employed in the outlet duct 16 or adjacent to the outlet duct 16 for distributing the steam 19 over the outlet face 20 of the adsorber bed. CO₂ is desorbed from the adsorber bed 13 by the steam 19 to create an enriched CO₂ fluid stream 22. The enriched CO₂ fluid stream 22 passes out of the adsorber bed inlet face 14 and into the inlet duct 11. The closed inlet valve 11A facilitates flow of the enriched CO₂ fluid stream 22 to the piping 23 for collection and/or further processing. The piping 23 is located outside the module 10 and is in fluid communication with the inlet duct 11 via one or more valves 23A. Valve(s) 23A and 18A are closed during the adsorption process in block A.

In some embodiments, the outlet duct is purged of any fluid stream 15 prior to beginning the desorption process. In such embodiments, the outlet valve 16A remains in the open position as steam 19 or other fluid is flowed into the outlet duct 16. The steam 19 and any fluid stream 15 in the outlet duct 16 is swept out of the module 10 through the outlet valve 16A. Once purging is complete, the outlet valve 16A closes and desorption begins. The inlet duct can also be purged prior to initiating the desorption process. Alternatively, in the purging process, the outlet duct 16 is closed via valve 16A, and the inlet duct 11 remains open. Steam 19 is passed into the outlet duct 16 from the steam source 18 through valve 18A. The steam 19 forces any fluid stream 15 residing in the outlet 16 and inlet 11 ducts out of the module via the open inlet duct 11. In this way, the outlet 16 and inlet 11 ducts can be simultaneously purged.

Block C illustrates cooling and/or drying of the adsorber bed, according to some embodiments. During cooling, a cooling fluid 24 is flowed into the outlet duct 16. The same piping for the desorption fluid, in some embodiments, can be employed to provide the cooling fluid 24 to the adsorber bed 13. The cooling fluid flows through the adsorber bed 13 and into the inlet duct 11. The inlet valve 11A is in the open position to permit the cooling fluid to exit the module 10. As illustrated in blocks A-C, the adsorber bed 13 as well as the inlet 11A and outlet 16A valves remain in a fixed or stationary location during adsorption, desorption, cooling/drying. The fixed location of these components greatly simplifies the CO₂ capture process by reducing or eliminating a number of moving parts found in prior CO₂ capture systems.

As described herein, a reactor can comprise multiple modules, each module independently operating or operating in concert with other modules in the adsorption mode, desorption mode, or cooling mode as described in FIG. 1 above.

In some embodiments, the module design can be altered to swap locations of the steam source 18 and piping 23 for collection of the enriched CO₂ stream. In such embodiments, adsorption would take place in the manner described for block A of FIG. 1. However, for desorption, the desorption fluid 19, such as steam, would enter the module through the inlet duct, and the enriched CO₂ stream would be captured through the outlet duct 16. Essentially, the desorption and cooling processes would run in reverse of that described above in FIG. 1.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A module for the capture of carbon dioxide (CO₂) from a fluid stream comprising:
a fluid stream inlet comprising an inlet duct and an inlet valve for reversibly sealing the inlet duct;
a bed for adsorption of the CO₂ from the fluid stream; and
a fluid stream outlet comprising an outlet duct and an outlet valve for reversibly sealing the outlet duct, wherein the fluid stream inlet duct is in fluid communication with piping for collection of an enriched CO₂ fluid stream, and the outlet duct is in fluid communication with a source of desorption fluid operable to effectuate desorption of CO₂ captured by the bed and/or a source of cooling fluid operable to reduce temperature of the bed.

2. The module of claim 1, wherein the inlet valve and outlet valve have a fixed location.

3. The module of claim 1, wherein the inlet duct comprises one or more baffles for directing fluid stream into the bed.

4. The module of claim 1, wherein an entrance to the inlet duct is non-parallel to the bed inlet face.

5. The module of claim 4, wherein the entrance is normal to the bed inlet face.

6. The module of claim 1, wherein the inlet duct traverses the entire bed.

7. The module of claim 1, wherein the piping is fixedly attached to one or more walls of the module.

8. The module of claim 1, wherein the outlet duct is in fluid communication with the desorption fluid source and/or cooling fluid source via delivery piping fixedly attached to one or more walls of the module.

9. The module of claim 8, wherein the desorption fluid source is steam.

10. The module of claim 1 further comprising a diffuser downstream of the bed.

11. The module of claim 10, wherein the diffuser distributes the desorption fluid over the entire bed.

12. The module of claim 10, wherein the diffuser is positioned in the outlet duct such that only a portion of the fluid stream passing through the bed also passes through the diffuser.

13. The module of claim 1, wherein an entrance to the outlet duct is non-parallel to the bed outlet face.

14. The module of claim 13, wherein the entrance is normal to the bed outlet face.

15. A reactor for the capture of carbon dioxide (CO₂) from a fluid stream comprising:
a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct, wherein the fluid stream inlet ducts of the first and second modules are in fluid communication with common piping for collection of enriched CO₂ fluid streams provided by the first and second modules, and the outlet ducts of the first and second modules are in fluid communication with a common source of desorption fluid operable to effectuate desorption of CO₂ captured by the beds and/or cooling fluid operable to reduce temperatures of the beds.

16. The reactor of claim 15, wherein the outlet ducts of the first and second modules are in fluid communication with the desorption fluid source and/or cooling fluid source via common delivery piping fixedly attached to one or more walls of the modules.

17. The reactor of claim 15, wherein the inlet and outlet ducts of the first and second modules are simultaneously sealed by the inlet and outlet valves.

18. The reactor of claim 17, wherein the inlet and outlet valves of the first and second modules have a fixed location.

19. A method of removing carbon dioxide (CO₂) from a fluid stream comprising:
providing a reactor including a first module and a second module, the first and second modules each comprising a fluid stream inlet comprising an inlet duct and an inlet valve for reversibly sealing the inlet duct, a bed for adsorption of CO₂ from the fluid stream, and a fluid stream outlet comprising an outlet duct and an outlet valve for reversibly sealing the outlet duct;
passing the fluid stream into the fluid stream inlet ducts of the first and second modules and in contact with the beds of the first and second modules to remove CO₂ from the fluid stream;
passing the fluid stream deficient in CO₂ through the outlet ducts of the first and second modules;
sealing the inlet ducts and outlet ducts of the first and second modules with the inlet valves and outlet valves;
passing a desorption fluid into the outlet ducts of the first and second modules to desorb CO₂ captured by the beds and generate an enriched CO₂ fluid stream;
passing the enriched CO₂ fluid stream through the inlet ducts of the first and second modules into piping for collection of the enriched CO₂ fluid stream from the first and second modules.

20. The method of claim 19, wherein the fluid is passed simultaneously into the outlet ducts of the first and second modules.

21. The method of claim 19, wherein the enriched CO₂ fluid stream is passed simultaneously from the first and second modules into the collection piping.

22. The method of claim 19, wherein the reactor further comprises at least one additional module, the at least one additional module comprising a fluid stream inlet comprising an inlet duct and an inlet valve for sealing the inlet duct, a bed for adsorption of CO₂ from the fluid stream, and a fluid stream outlet comprising an outlet duct and an outlet valve for sealing the outlet duct,
wherein the fluid stream is passed into the inlet duct of the at least one additional module and in contact with the bed of the at least one additional module to remove CO₂ from the fluid stream while the CO₂ captured by the beds of the first and second modules is desorbed to produce the enriched CO₂ fluid stream.

23. The method of claim 19, wherein the fluid stream is ambient air or a flue gas or process gas stream.
